(19) United States
(12) Patent Application Publication
(10) Pub. No.: US 2013/0047818 A1
(43) Pub. Date: Feb. 28, 2013

(54) BRASS SILENCER

(71) Applicant: Shinji HAMANAGA, Hamamatsu-shi (JP)

(72) Inventor: Shinji HAMANAGA, Hamamatsu-shi (JP)

(21) Appl. No.: 13/569,687

(22) Filed: Aug. 8, 2012

(30) Foreign Application Priority Data
Aug. 23, 2011 (JP) 2011-181055

(51) Int. Cl. G10D 9/06

(52) U.S. Cl. 84/400

(57) ABSTRACT

The present invention has a sufficient silencing effect, and improves resistance of breath upon blowing and stability of a tone to normal musical performance and substantially improves breathlessness and difficulty in blowing while having a compact size which hardly projects from a bell. With a brass silencer which has a silencer body (10) attached to a bell (20) of a brass, the silencer (10) has a body internal space (11), the silencer body (10) is provided with: a breath injection pipe (4) which injects breath in the body internal space (11); and a breath ejection pipe (5) which has a breath ejection channel (13) which communicates to a pipe internal space (2) of the breath injection pipe (4) and ejects breath to an external space, and an injection side inner diameter of the breath injection pipe (4) is made greater than a minimum inner diameter of the silencer body (10).

### BACKGROUND OF THE INVENTION

1. Field of the Invention

The present invention relates to a silencer used for brasses such as trumpets and trombones and, more particularly, the present invention relates to a mute brass silencer used for a purpose of reducing a sound volume.

2. Description of the Related Art

The applicant has proposed a conventional mute brass silencer which is formed with a head part and a body part and has a silencer body having a maximum inner diameter at the head part, and in which an ejection groove is further formed between an inner peripheral surface of a bell and an outer peripheral surface of the body part (Japanese Patent Application Laid-Open No. 2001-282233). This brass silencer improves a silencing effect by ejecting breath of a musical performer which has entered inside the silencer body, to external space through communication space of the ejection groove, and reducing the sound volume leaking to the external space.

Thus, although the silencer which is attached to a bell of a brass to reduce the sound volume can mute a large sound volume of the brass to a level of conversation in small voice in recent years, the silencer has a drawback that resistance of breath upon blowing is great and stability of the tone is not sufficient compared to normal musical performance without the silencer, and therefore it is difficult to blow the brass.

The present invention is made in light of this problem, and an object of the present invention is to provide a brass silencer which has a sufficient silencing effect, and which improves resistance of breath upon blowing and stability of a tone to normal musical performance and substantially improves breathlessness and difficulty in blowing while having a compact size which hardly projects from a bell.

### SUMMARY OF THE INVENTION

In order to solve the problem and achieve the object, the present invention is formed as follows.

According to a first aspect of the present invention, there is provided a brass silencer including a silencer body attached to a bell of a brass, wherein the silencer body has a body internal space, and the silencer body is provided with: a breath injection pipe which injects breath in the body internal space; and a breath ejection pipe which includes a breath ejection channel, and an injection side inner diameter of the breath injection pipe is made greater than a minimum inner diameter of the silencer body.

According to a second aspect of the present invention, the brass silencer according to the first aspect of the present invention includes the breath injection pipe having a cylindrical shape having an equal injection side inner diameter and ejection side inner diameter of the breath injection pipe.

According to a third aspect of the present invention, the brass silencer according to the first aspect of the present invention includes the breath injection pipe having a tapered cylindrical shape having an ejection side inner diameter which becomes gradually smaller than an injection side inner diameter of the breath injection pipe.

According to a fourth aspect of the present invention, the brass silencer according to the first aspect of the present invention includes the breath injection pipe having a spatulate cylindrical shape having an ejection side inner diameter which becomes gradually greater than an injection side inner diameter of the breath injection pipe.

According to a fifth aspect of the present invention, the brass silencer according to anyone of the first to fourth aspects of the present invention includes a power source and an electronic module outside the silencer body, and a microphone on a side closer to a silencer internal space than a minimum inner diameter part of the silencer body, wherein the power source and the electronic module, and the microphone are connected through a signal line.

According to the configuration, the present invention provides the following effect.

With the invention according to the first aspect to the fourth aspect of the present invention, although breath enters the body internal space of the silencer body attached to the bell of the brass, the silencer body is provided with the breath injection pipe which injects breath in the body internal space and the breath ejection pipe having a breath ejection channel, and the injection side inner diameter of the breath injection pipe is made greater than the minimum inner diameter of the silencer body, thereby preventing this breath from entering the body internal space from the pipe internal space of the breath injection pipe and from being ejected to the external space passing the breath ejection channel, and preventing the sound wave from propagating to an outside through the breath injection pipe and the breath ejection pipe. Consequently, the brass silencer can support various brasses, reduce the sound volume leaking to external space and stably improve a silencing effect, and can improve resistance of breath upon blowing and stability of a tone to normal musical performance and substantially improve breathlessness and difficulty in blowing while having a compact size which hardly projects from a bell.

The invention according to the fifth aspect of the present invention has the power source and the electronic module outside the silencer body and has a microphone on a side closer to the internal space of the silencer body than the minimum inner diameter part of the silencer body, and can connect the power source, the electronic module and the microphone through the signal line and provide usability as an all-in-one silencer while providing a practically and sufficiently small size even when the power source and the electronic module are embedded in the silencer, so that it is possible to freely and comfortably set musical performance space upon musical performance.

### BRIEF DESCRIPTION OF THE DRAWINGS

FIG. 1 is a sectional view of a brass silencer according to a first embodiment;

FIG. 2 is a sectional view of the brass silencer attached to a trumpet;

FIG. 3 is a perspective view of the brass silencer;

FIG. 4 is a front view of the brass silencer;

FIG. 5 is a left side view of the brass silencer;

FIG. 6 is a right side view of the brass silencer;

FIG. 7 is a plan view of the brass silencer;

FIG. 8 is a bottom view of the brass silencer;

FIG. 9 is a back view of the brass silencer;

FIG. 10 is a sectional view of a brass silencer according to the second embodiment;

FIG. 11 is a sectional view of a brass silencer according to a third embodiment;

FIG. 12 is a sectional view of a brass silencer according to a fourth embodiment;

FIG. 13 is a sectional view of a brass silencer according to a fifth embodiment; and

FIG. 14 is a front view of the brass silencer according to the fifth embodiment.

### DETAILED DESCRIPTION OF EMBODIMENTS

Although embodiments of a brass silencer according to the present invention will be described below, this description of embodiment illustrates the best mode for the embodiment, and the present invention is by no means limited to this.

### First Embodiment

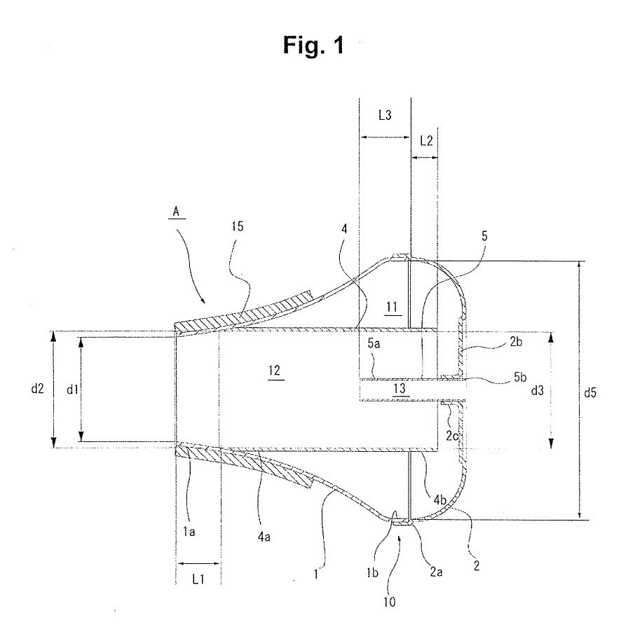

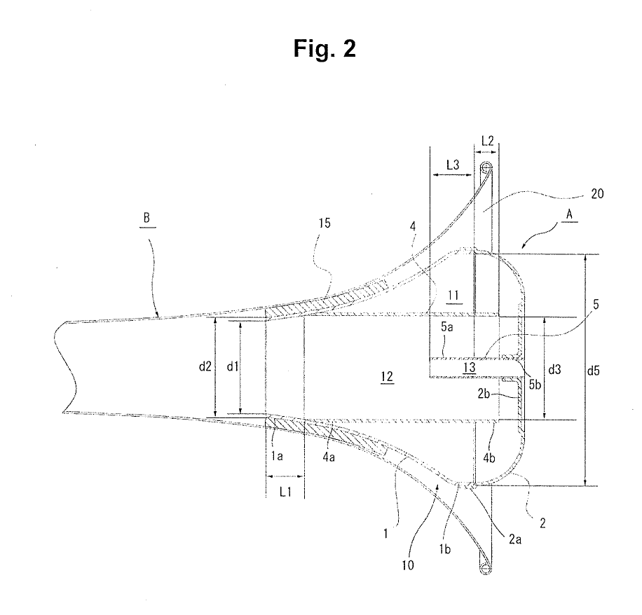

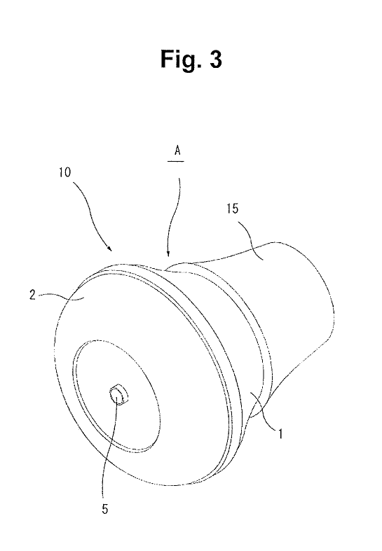

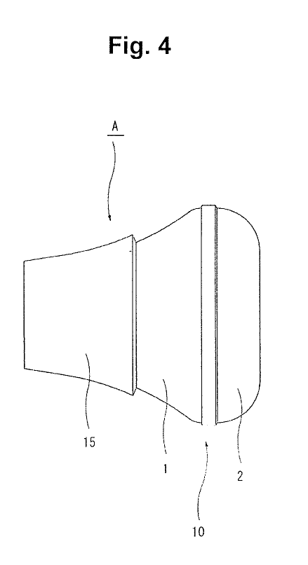

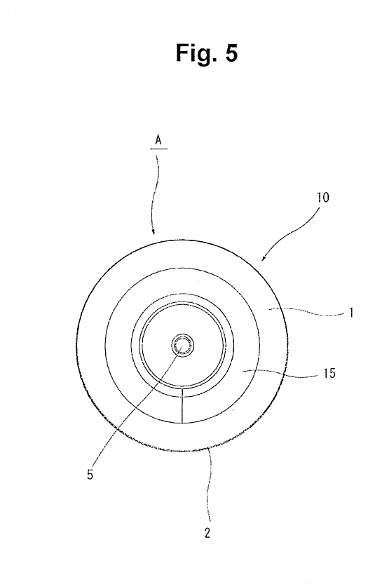

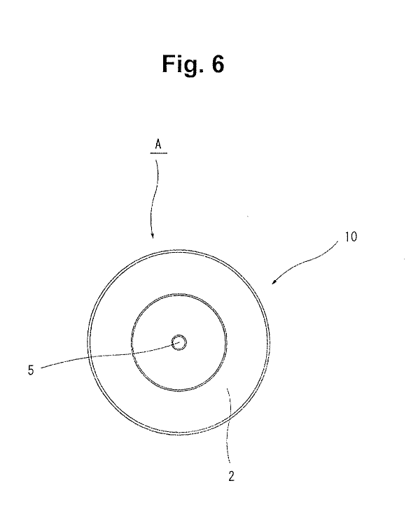

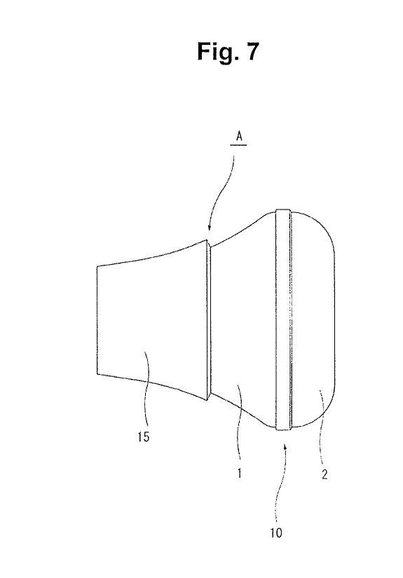

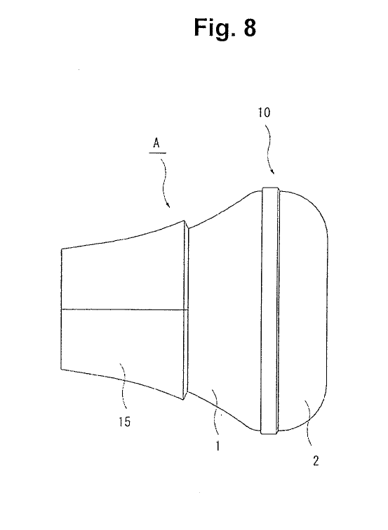

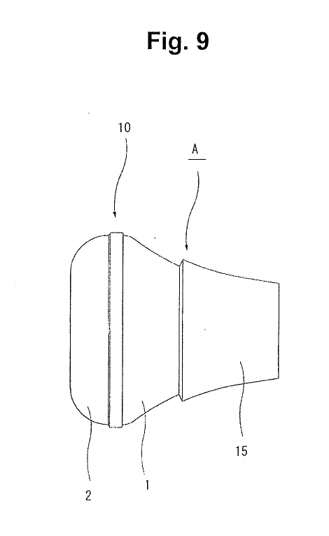

A brass silencer according to a first embodiment of the present invention will be described below in details based on FIGS. 1 to 9. FIG. 1 is a sectional view of a brass silencer, FIG. 2 is a sectional view of the brass silencer attached to a trumpet, FIG. 3 is a perspective view of the brass silencer, FIG. 4 is a front view of the brass silencer, FIG. 5 is a left side view of the brass silencer, FIG. 6 is a right side view of the brass silencer, FIG. 7 is a plan view of the brass silencer, FIG. 8 is a bottom view of the brass silencer, and FIG. 9 is a back view of the brass silencer.

A brass silencer A according to the present embodiment is detachable to a bell 20 of a trumpet B, and is used particularly for the purpose of reducing a sound emitted from the bell 20 of the trumpet B and the sound volume. The brass silencer A has a silencer body 10 attached to the bell 20 of the trumpet B. This silencer body 10 has a body part 1 and a head part 2, and includes body internal space 11.

The body part 1 is made of metal molded using aluminum, and can be implemented using various materials using plastic or hard paper. This body part 1 is comparatively smoothly inclined to match the shape of the inner peripheral surface of the bell 20, and has a small diameter side end part 1a and a large diameter side end part 1b. On an outer peripheral surface on a side of this small diameter side end part 1a, a flexible attachment member 15 is provided.

When the silencer body 10 is attached to the bell 20, an outer peripheral surface on the small diameter side end part 1a side of the body part 1 fits with the inner peripheral surface of the bell 20 through the flexible attachment member 15. Although the flexible attachment member 15 only needs to have deformable flexibility, is a rubber member, a resin member, a cork or a cloth member and is pasted to the body part 1 by a double-sided tape, the flexible attachment part 15 may be pasted using an adhesive, and closely attached to, fits with and is fixed to the inner peripheral surface of the bell 20 well thanks to the property of this material to prevent breath from leaking.

Although the head part 2 is made of metal molded using aluminum, the head part 2 can be implemented using various materials such as plastic or hard paper. The head part 2 has a bowl shape, an opening end 2a fits with and is adhered to and fixed to the large diameter side end part 1b of the body part 1b of the body part 1 and the fitting part is sealed to prevent air in the body internal space 11 of the silencer body 10 from leaking. By this means, it is possible to play stable sound without unevenness in resonance in the gamut.

The silencer body 10 is provided with a breath injection pipe 4 which injects breath in the body internal space 11 and a breath ejection pipe 5 which has a breath ejection channel 13 which communicates to pipe internal space 12 of the breath injection pipe 4 and ejects breath to external space, and is configured to prevent the sound wave from propagating to an outside by means of the breath injection pipe 4 and the breath ejection pipe 5.

The breath injection pipe 4 has a cylindrical shape having the same injection side inner diameter d2 and ejection side inner diameter d3, an injection side 4a is adhered to and fixed to the small diameter side end part 1a side of the body part 1 and an ejection side 4b is opened in the body internal space 11. The injection side 4a of this breath injection pipe 4 is positioned at a distance L1 from the end surface on the injection side 1a of the silencer body 10, the injection side inner diameter d2 of the breath injection pipe 4 is greater than the minimum inner diameter d1 of the silencer body 10, and the end surface of the ejection side 4b is positioned at a distance L2 from the position of a maximum inner diameter d5 of the silencer body 10.

The breath ejection pipe 5 has a cylindrical shape having same injection side inner diameter and ejection side inner diameter. The ejection side 5b of the breath ejection pipe 5 is adhered to and fixed to a flange part 2c further extending toward an inner side from a base 2b formed by denting the center part of the head part 2 toward the inner side, and the injection side 5a is opened in the pipe internal space 12. The end surface on the injection side 5a of the breath ejection pipe 5 is positioned at the distance L3 from the position of the maximum inner diameter d5 of the silencer body 10.

The inner diameters and the lengths of the breath injection pipe 4 and the breath ejection pipe 5 are by no means limited in particular as long as they can form resistance which allows the sound wave to pass, reduce the sound volume leaking to external space and stably improve silencing effect. Further, although the breath injection pipe 4 and the breath ejection pipe 5 are made of metal molded using aluminum, the breath injection pipe 4 and the breath ejection pipe 5 can be implemented using various materials such as plastic or hard paper. It is naturally possible to integrally mold the body part 1 and the breath injection pipe 4, and the head part 2 and the breath ejection pipe 5.

With the present embodiment, by attaching the body part 1 of the silencer body 10 to the bell 20 of the trumpet B, breath blown in by a musical performer is blown in from a mouth piece, enters the pipe internal space 12 passing the injection side 4a of the breath injection pipe 4 from the small diameter side end part 1a of the body part 1, and enters the body internal space 11 from the ejection side 4b passing the pipe internal space 12 and is ejected to external space passing the breath ejection channel 13 of the breath ejection pipe 5. In this case, inside the brass, an acoustic mode acoustically occurs in a pipe closed at both ends on a mouth piece side which is an inlet for breath and on the breath ejection pipe 5 side of the silencer body 10 which is an outlet.

Thus, the silencer body 10 is provided with the breath injection pipe 4 which injects breath in the body internal space 11 and the breath ejection pipe 5 which includes the breath ejection channel 13 which communicates to the pipe internal space 12 of the breath injection pipe 4 and ejects breath to external space, the breath enters the body internal space 11 from the pipe internal space 12 of the breath injection pipe 4 and is ejected to external space passing the breath ejection channel 13, so that, by preventing the sound wave from propagating to an outside by means of resistance in the channels of the breath injection pipe 4 and the breath ejection pipe 5, it is possible to support various brasses, reduce the sound volume leaking to the external space and stably improve the silencing effect.

Further, the injection side inner diameter d2 of the breath injection pipe 4 is greater than the minimum inner diameter d1 of the silencer body 10, and the breath injection pipe 4 has a cylindrical shape having the same injection side inner diameter d2 and ejection side inner diameter d3 of the breath injection pipe 4, so that it is possible to improve resistance of breath upon blowing and stability of the tone almost to normal musical performance, and substantially improve breathlessness and difficulty in blowing.

Furthermore, when the silencer body 10 is attached to the bell 20, the maximum inner diameter d5 of the silencer body 10 is positioned in the end surface of the bell 20, and, upon comparison with the dimension of a conventional silencer, when the silencer body 10 is attached by way of insertion, the silencer body projects forward over a smaller distance from the end surface of the bell 20, and can more accurately maintain the balance in the tone while having a compact size and play stable sound without unevenness in resonance in the gamut.

Still further, the breath injection pipe 4 and the breath ejection pipe 5 are arranged and end parts of these pipe members are attached to the interior of the silencer body 10, and the silencer body 10 adopts a simple silencer structure to which the pipe members are attached.

### Second Embodiment

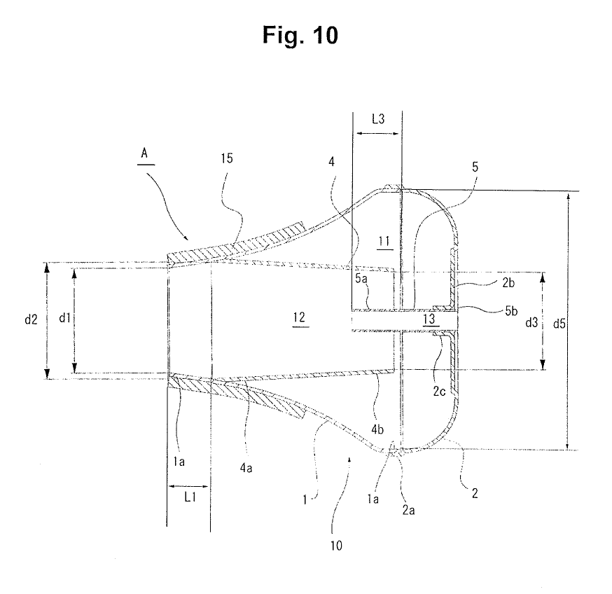

A second embodiment of the present invention will be described below based on FIG. 10. In addition, the same configuration as in the first embodiment will be assigned the same reference numerals, and will not be described. With the present embodiment, a breath injection pipe 4 has a tapered cylindrical shape having an ejection side inner diameter d3 which becomes gradually smaller than an injection side inner diameter d2, and an injection side 4a is closely attached to and fixed to a smaller diameter side end part 1a side of the silencer body 10 and an ejection side 4b is opened in body internal space 11.

The injection side 4a of the breath injection pipe 4 is positioned at a distance L1 from an end surface of the injection side 1a of the silencer body 10, the injection side inner diameter d2 of the breath injection pipe 4 is greater than the minimum inner diameter d1 of the silencer body 10 and the end surface of the ejection side 4b is positioned at a position of a maximum inner diameter d5 of the silencer body 10.

With the present embodiment, the injection side inner diameter d2 of the breath injection pipe 4 is greater than the minimum inner diameter d1 of the silencer body 10, and the breath injection pipe 4 has a tapered cylindrical shape having the ejection side inner diameter d3 which becomes gradually smaller than the injection side inner diameter d2 of the breath injection pipe 4, so that it is possible to improve resistance of breath upon blowing and stability of a tone almost to normal musical performance, and substantially improve breathlessness and difficulty in blowing. The ejection side inner diameter d3 of the breath injection pipe 4 is adequately set for the sake of design of a tone, and, while blowing resistance is increased by setting a smaller ejection side inner diameter d3 than the minimum diameter d1 of the silencer body 10, it is possible to prevent an increase in blowing resistance by shortening the breath injection pipe 4.

### Third Embodiment

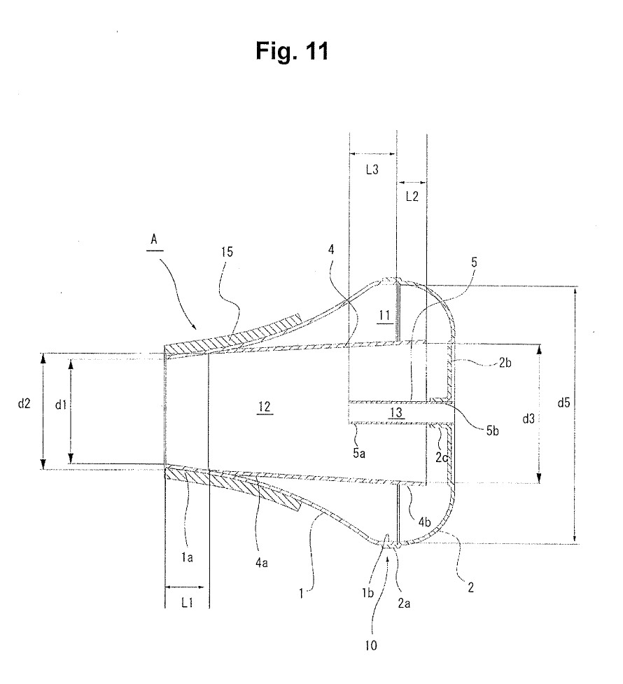

A third embodiment of the present invention will be described below based on FIG. 11. In addition, the same configurations as in the first embodiment will be assigned the same reference numerals, and will not be described. According to the present embodiment, a breath injection pipe 4 has a spatulate cylindrical shape having an ejection side inner diameter d3 which becomes gradually greater than an injection side inner diameter d2, and an injection side 4a is closely attached to and fixed to a small diameter side end part 1a side of a silencer body 10 and an ejection side 4b is opened in body internal space 11.

The injection side 4a of the breath injection pipe 4 is positioned at a distance L1 from an end surface of an injection side 1a of the silencer body 10, and the injection side inner diameter d2 of the breath injection pipe 4 is greater than a minimum inner diameter d1 of the silencer body 10 and the end surface of the ejection side 4b is positioned at a position of a distance L2 from the position of a maximum d5 of the silencer body 10.

With the present embodiment, the injection side inner diameter d2 of the breath injection pipe 4 is greater than the minimum inner diameter d1 of the silencer body 10, and the breath injection pipe 4 has a spatulate cylindrical shape having the ejection side inner diameter d3 which becomes gradually greater than the injection side inner diameter d2 of the breath injection pipe 4, so that it is possible to improve resistance of breath upon blowing and stability of a tone almost to normal musical performance, and substantially improve breathlessness and difficulty in blowing. The ejection side inner diameter d3 of the breath injection pipe 4 is adequately set for the sake of design of a tone, and, by setting a greater ejection side inner diameter d3 than the minimum diameter d1 of the silencer body 10, an increase in blowing resistance is suppressed.

With the second embodiment, the breath injection pipe 4 has a tapered shape having the ejection side inner diameter d3 which becomes gradually smaller than the injection side inner diameter d2, and, with the third embodiment, the breath injection pipe 4 has a spatulate cylindrical shape having the ejection side inner diameter d3 which becomes gradually greater than the injection side inner diameter d2 and does not need to have a cylindrical shape having the same diameter injection side inner diameter d2 and ejection side inner diameter d3 unlike the first embodiment and may have an adequately set shape for the sake of design of a tone.

Further, the length of the breath injection pipe 4 influences on a pitch of musical instrument, and, when the breath injection pipe 4 is longer, the pitch becomes lower and, when the breath injection pipe 4 is shorter, the pitch becomes higher. Meanwhile, when the thickness of the breath injection pipe 4 becomes thinner, the pitch becomes lower and, when the thickness of the breath injection pipe 4 becomes thicker, the pitch becomes higher, so that factors such as the length and the thickness of the breath injection pipe 4 and the intermediate shape intricately intertwine, thereby substantially influencing on a pitch, the balance in a tone, blowing resistance and stability of the tone, and are adequately set for the sake of design of the tone.

### Fourth Embodiment

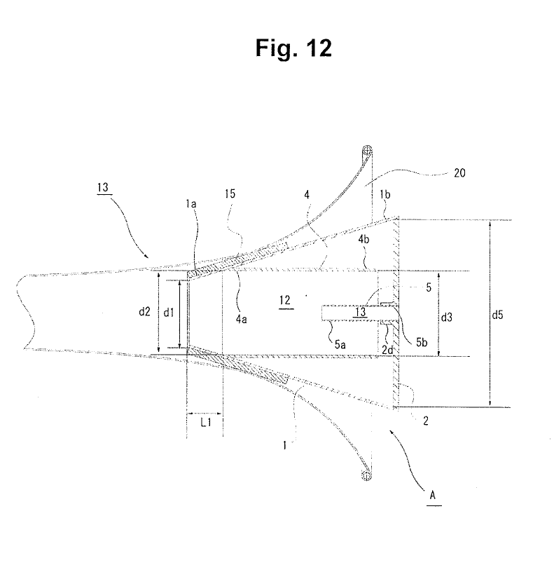

A fourth embodiment of the present invention will be described below based on FIG. 12. In addition, the same configuration as in the first embodiment will be assigned the same reference numerals, and will not be described. With the present embodiment, the silencer body 10 has a body part 1 and a head part 2, and includes body internal space 11. The body part 1 has a spatulate cylindrical shape and has a small diameter side end part 1a and a larger diameter side end part 1b, and the disc-shaped head part 2 is closely attached and fixed to block the large diameter end part 1b of the body part 1.

On an outer peripheral surface on a side of the small diameter side end part 1a of the body part 1, a flexible attachment member 15 is provided, and, when the silencer body 10 is attached to the bell 20, the outer periphery of the small diameter side end part 1a side of the body part 1 fits with the inner peripheral surface of the bell 20 through the flexible attachment member 15.

The breath injection pipe 4 has a cylindrical shape having the same injection side inner diameter d2 and ejection side inner diameter d3, an injection side 4a is fixed to the small diameter side end part 1a side of the body part 1 and an ejection side 4b is opened in the body internal space 11. The injection side 4a of the breath injection pipe 4 is positioned at a distance L1 from the end surface on the injection side 1a of the silencer body 10, the injection side inner diameter d2 of the breath injection pipe 4 is greater than the minimum inner diameter d1 of the silencer body 10, and the end surface of the ejection side 4b is positioned at a distance L3 from the position of a maximum inner diameter d5 of the silencer body 10.

The breath ejection pipe 5 has a cylindrical shape having same injection side inner diameter d2 and ejection side inner diameter d3, and includes a breath ejection channel 13. The ejection side 5b of the breath ejection pipe 5 is closely attached to and fixed to a flange part 2d formed in a center part of the head part 2 and extending toward an inner side, and the injection side 5a is opened in the pipe internal space 12.

Further, the injection side inner diameter d2 of the breath injection pipe 4 is greater than the minimum inner diameter d1 of the silencer body 10, and the breath injection pipe 4 has a cylindrical shape having the same injection side inner diameter d2 and ejection side inner diameter d3 of the breath injection pipe 4, so that it is possible to improve resistance of breath upon blowing and stability of the tone almost to normal musical performance, and substantially improve breathlessness and difficulty in blowing.

### Fifth Embodiment

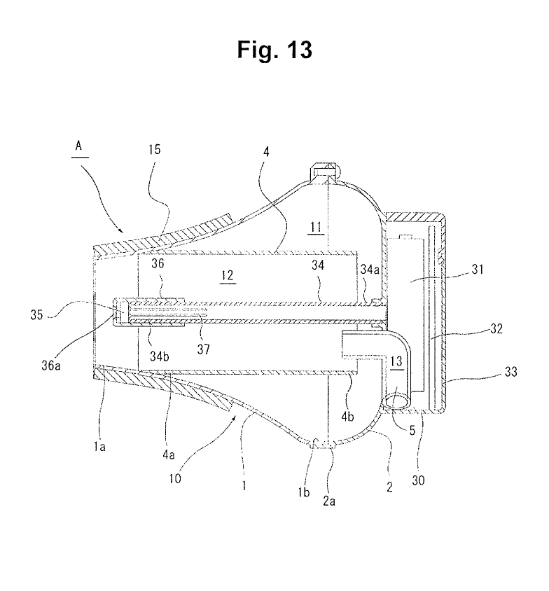

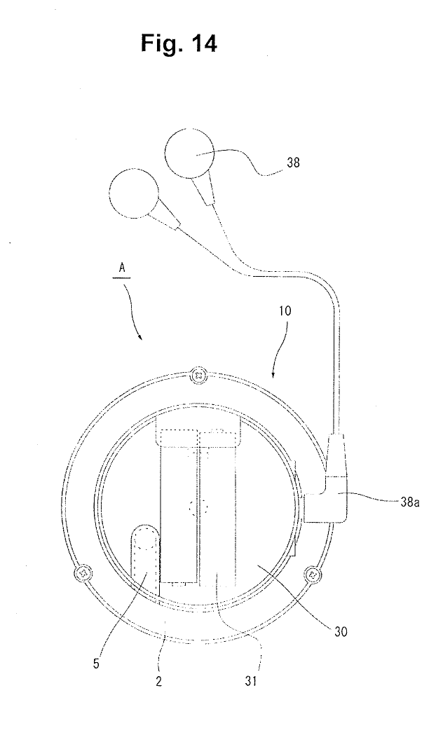

A fifth embodiment of the present invention will be described below based on FIGS. 13 and 14. FIG. 13 is a sectional view of a brass silencer, and FIG. 14 is a front view of the brass silencer without a cover. In addition, the same configuration as in the first embodiment will be assigned the same reference numerals, and will not be described. With the present embodiment, a silencer body 10 is integrally formed with an accommodating part 30 on an outer surface in the center of a head part 2, and two batteries which are a power source 31 and an electronic module 32 are arranged inside this accommodating part 30. The accommodating part 30 is provided with a removable cover 33, and this cover 33 allows weak batteries to be exchanged.

A connecting part 38a of earphones 38 is detachable to the accommodating part 30, and the connecting part 38a of the earphones 38 are connected with the electronic module 32. A breath ejection pipe 5 is opened to an outside through the accommodating part 30, and breath is ejected to external space passing a breath ejection channel 13.

In the center of the head part 2, a base part 34a of an attachment pipe 34 is fixed, and this attachment pipe 34 passes pipe internal space 12 of the breath injection pipe 4 and a microphone 35 is attached to a front end part 34b by an attachment cover 36. A signal line 37 of the microphone 35 is connected to the electronic module 32 passing inside the attachment pipe 34.

In the attachment cover 36, a sound collector hole 36a is opened at a position opposing to the microphone 35, and the microphone 35 collects sound from the sound collector hole 36a. The microphone 35 is positioned at a place where the balance of a sound pressure of an effective standing wave of each sound is good, so that it is possible to pick up well-balanced sound over the gamut.

Thus, the silencer has the power source 31 and the electronic module 32 outside the silencer body 10 and has the microphone 35 in the pipe internal space 12 of the silencer body 4, and can connect the power source 31, the electronic module 32 and the microphone 35 through the signal line 37 and provide usability as an all-in-one silencer while providing a practically and sufficiently small size even when the power source 31 and the electronic module 32 are embedded in the silencer body 10, so that it is possible to freely and comfortably set musical performance space upon musical performance.

Although the embodiments of the present invention have been described above, a specific configuration is by no means limited to these embodiments, even modification of design within a range which does not deviate from the spirit of the present invention is included in the range of the present invention. Naturally, a brass to which the silencer according to the present invention is by no means limited to a trumpet.

The present invention relates to a silencer used for brasses such as trumpets and trombones and is applicable to a mute brass silencer used particularly for the purpose of reducing the sound volume, and supports various brasses, reduces the sound volume leaking to external space, provides a sufficiently silencing effect, and improves resistance of breath upon blowing and stability of the tone to normal musical performance and substantially improves breathlessness and difficulty in blowing while having a compact size which hardly projects from a bell.

### REFERENCE SIGNS LIST

A BRASS SILENCER
B TRUMPET
d1 MINIMUM INNER DIAMETER
d2 INJECTION SIDE INNER DIAMETER
d3 EJECTION SIDE INNER DIAMETER
d5 MAXIMUM INNER DIAMETER
1 BODY PART
1a SMALL DIAMETER SIDE END
1b LARGE DIAMETER SIDE END
2 HEAD PART
2a OPENING END
2b BASE
2c FLANGE PART
4 BREATH INJECTION PIPE
4a INJECTION SIDE
4b EJECTION SIDE
5 BREATH EJECTION PIPE
5a INJECTION SIDE
5b EJECTION SIDE
10 SILENCER BODY
11 BODY INTERNAL SPACE
12 PIPE INTERNAL SPACE
13 BREATH EJECTION CHANNEL
15 FLEXIBLE ATTACHMENT MEMBER
20 BELL
30 ACCOMMODATING PART
31 POWER SOURCE
32 ELECTRONIC MODULE
35 MICROPHONE
36 ATTACHMENT COVER
36a SOUND COLLECTOR HOLE
37 SIGNAL LINE
38 EARPHONE
38a CONNECTING PART

1. A brass silencer comprising a silencer body attached to a bell of a brass, wherein
the silencer body comprises a body internal space,
the silencer body is provided with:
a breath injection pipe which injects breath in the body internal space; and
a breath ejection pipe which comprises a breath ejection channel, and
an injection side inner diameter of the breath injection pipe is made greater than a minimum inner diameter of the silencer body.

2. The brass silencer according to claim 1, wherein the breath injection pipe comprises a cylindrical shape comprising an equal injection side inner diameter and ejection side inner diameter of the breath injection pipe.

3. The brass silencer according to claim 1, wherein the breath injection pipe comprises a tapered cylindrical shape comprising an ejection side inner diameter which becomes gradually smaller than an injection side inner diameter of the breath injection pipe.

4. The brass silencer according to claim 1, wherein the breath injection pipe comprises a spatulate cylindrical shape comprising an ejection side inner diameter which becomes gradually greater than an injection side inner diameter of the breath injection pipe.

5. The brass silencer according to claim 1, further comprising:
a power source and an electronic module outside the silencer body; and
a microphone on a side closer to a silencer internal space than a minimum inner diameter part of the silencer body,
wherein the power source and the electronic module, and the microphone are connected through a signal line.
